(19) United States
(12) Patent Application Publication
(10) Pub. No.: US 2014/0065960 A1
(43) Pub. Date: Mar. 6, 2014

(54) DEVICE AND METHOD FOR SHARING CONTENT

(71) Applicant: Pantech Co., Ltd., Seoul (KR)

(72) Inventors: Gu-Byeong GANG, Seoul (KR); Jong-Hyun LEE, Seoul (KR)

(73) Assignee: Pantech Co., Ltd., Seoul (KR)

(21) Appl. No.: 14/013,998

(22) Filed: Aug. 29, 2013

(30) Foreign Application Priority Data
Aug. 31, 2012 (KR) 10-2012-0096712

(51) Int. Cl. H04B 5/00

(52) U.S. Cl. CPC H04B 5/00
USPC 455/41.1

(57) ABSTRACT

A method for sharing content includes establishing a short range communication link between a first device and a second device, identifying one or more components of a program being executed in at least one of a foreground and a background of the first device, and transmitting, to the second device, common data of at least one of the identified components. A first device includes a control unit to identify one or more components of a program being executed in at least one of a foreground and a background, and a wireless communication unit to establish a short range communication link with a second device, and to transmit, to the second device, common data of at least one of the identified components.

### CROSS-REFERENCE TO RELATED APPLICATION

This application claims priority from and the benefit under 35 U.S.C. §119(a) of Korean Patent Application No. 10-2012-0096712, filed on Aug. 31, 2012, which is hereby incorporated herein by reference for all purposes.

### BACKGROUND

1. Field

The following description relates to a method of sharing content between devices.

2. Discussion of the Background

With the rapid development of information communication technologies, types of mobile devices have diversified. In addition, the capabilities of mobile devices have improved. Due, at least in part, to the application of improved capabilities of the mobile devices, a greater variety of functions became available on the mobile devices, and the development of new functions has been continuing. Further, as the mobile devices, such as smartphones, tablet personal computers (PCs), and the like, have become more frequently used, personally and professionally, the use of content through the mobile devices has increased. With the expanding distribution of mobile devices among people and individuals often owning multiple mobile devices, the need to share content between the mobile devices is increasing.

Near Field Communication (NFC) is a type of peer-to-peer (P2P) short-range communication technology, which allows exchange of various types of wireless data within a very short distance. The current NFC allows communications within a distance of a few centimeters using the frequency band of 13.56 megahertz (MHz). Further, P2P short-range communication technologies include Bluetooth®, Wi-Fi Direct®, Zigbee®, and the like. NFC has a limited transmission capacity and narrower communication range compared to the other P2P short-range communication technologies, but is more secure and can be implemented at a low cost. In addition, because communication is possible between NFC devices over an NFC link, which is set up simply by touching NFC tags of the NFC devices with each other, the NFC devices do not need additional setup processes for a communication link therebetween, which is required in Bluetooth® or Wi-Fi Direct®.

Recent smartphones equipped with Android® operating system (OS) have NFC chips embedded therein to allow use of NFC technology, and it is anticipated that smartphones equipped with other OSs, such as Apple's iOS®, will have NFC chips embedded within the coming hardware generations. By reflecting such trend, various functions and applications have been developed utilizing NFC, including Android Beam® offered by Android® OS, to allow sharing of content between devices. Android Beam® is a feature that was first introduced in the Ice Cream Sandwich® version of Android® OS, and allows a reception device to display the same screen as displayed on a transmission device.

FIG. 1 is a flowchart illustrating a method for sharing content between mobile devices using an NFC scheme according to a related art.

Referring to FIG. 1, a transmission device and a reception device, equipped with NFC tags, come in contact with each other to activate or initialize the NFC tags in operation 11. The operation 11 allows the transmission device and the reception device to recognize each other and to set up a link for communications therebetween. In addition, the transmission device may check whether an activity of an application currently appearing on a display, more specifically, a foreground activity, supports content sharing operation in operation 12. If it is determined that the foreground activity does not support content sharing operation, the flow does not proceed to the subsequent operation for transmitting data for content sharing (hereinafter, referred to as “common data”) and the method for sharing content ends. If it is determined that the foreground activity supports the NFC transmission, the operations for transmitting the common data from the transmission device to the reception device are performed.

For transmitting the common data, the transmission device may display a menu item, such as “share”, on a touch screen to execute transmission of content in operation 13. In response to receiving a user's input on the menu item, such as a touch input being detected, the transmission device transmits the common data to the reception device using NFC in operation 14. When the transmission of content is completed in operation 14, the NFC link between the transmission device and the reception device is cancelled. Subsequently, the reception device executes the same foreground activity as the foreground activity executed by the transmission device using the received common data, and displays the activity on its touch screen in operation 15.

According to the content sharing method utilizing NFC in the related art, the transmission device is able to share content with the reception device by activating each device's NFC tags and entering in an input to request the transmission. However, the existing content sharing method may be subject to limitations in type and/or amount of content. More specifically, the transmission device can only share an activity that is currently displayed on a display or content that constitutes an activity displayed on top of its display (or on the foreground) with the reception device. In addition, the existing content sharing method may only support limited types of content, such as a browser, contacts, YouTube® clips, and the like, and does not support other types of content. Moreover, once common data is transmitted from the transmission device to the reception device, the NFC link between the transmission device and the reception device is automatically cancelled or severed. Thus, when a large number of contents are to be shared, the operations of FIG. 1 need to be repeatedly performed for each of the contents to be shared.

### SUMMARY

Exemplary embodiments of the present invention provide a method of sharing content between devices.

Additional features of the invention will be set forth in the description which follows, and in part will be apparent from the description, or may be learned by practice of the invention.

Exemplary embodiments of the present invention provide a method for sharing content including establishing a short range communication link between a first device and a second device; identifying one or more components of a program being executed in at least one of a foreground and a background of the first device; and transmitting, to the second device, common data of at least one of the identified components.

Exemplary embodiments of the present invention provide a first device including a control unit to identify one or more components of a program being executed in at least one of a foreground and a background; and a wireless communication unit to establish a short range communication link with a second device, and to transmit, to the second device, common data of at least one of the identified components.

Exemplary embodiments of the present invention provide a method for sharing content including establishing a short range communication link between a first device and a second device; establishing a wireless communication link between the first device and the second device; identifying one or more components of a program being executed in at least one of a foreground and a background of the first device; determining a transmission method for transmitting common data of at least one of the identified components; and transmitting, to the second device, common data of the at least one of the identified components according to the determined transmission method.

Exemplary embodiments of the present invention provide a receiving device including a wireless communication unit to establish a short range communication link with a transmitting device, and to receive, from the transmitting device, common data of one or more components of a program executed in at least one of a foreground and a background of the transmitting device; and a control unit to execute at least one component corresponding to at least one of the components of the program executed in the transmitting device using the received common data.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a flowchart illustrating a method for sharing content between devices using a Near Field Communication (NFC) scheme according to a related art.

FIG. 2 is a block diagram illustrating a configuration of a device capable of sharing content according to an exemplary embodiment of the present invention.

FIG. 3 is a diagram illustrating a program stack and component stacks of each program executed in a device according to an exemplary embodiment of the present invention.

FIG. 4 is a flowchart illustrating a method for sharing content between devices according to an exemplary embodiment of the present invention.

FIG. 5 is a diagram illustrating a component list appearing on a display of a transmission device according to an exemplary embodiment of the present invention.

FIG. 6 is a flowchart illustrating a method for sharing content between devices according to an exemplary embodiment of the present invention.

FIG. 7 is a diagram illustrating a component list appearing on a display of a transmission device according to an exemplary embodiment of the present invention.

FIG. 8A and FIG. 8B are flowcharts illustrating methods for establishing a non-NFC link between devices according to exemplary embodiments of the present invention.

FIG. 9A and FIG. 9B are flowcharts illustrating methods for establishing a non-NFC link, between devices according to exemplary embodiments of the present invention.

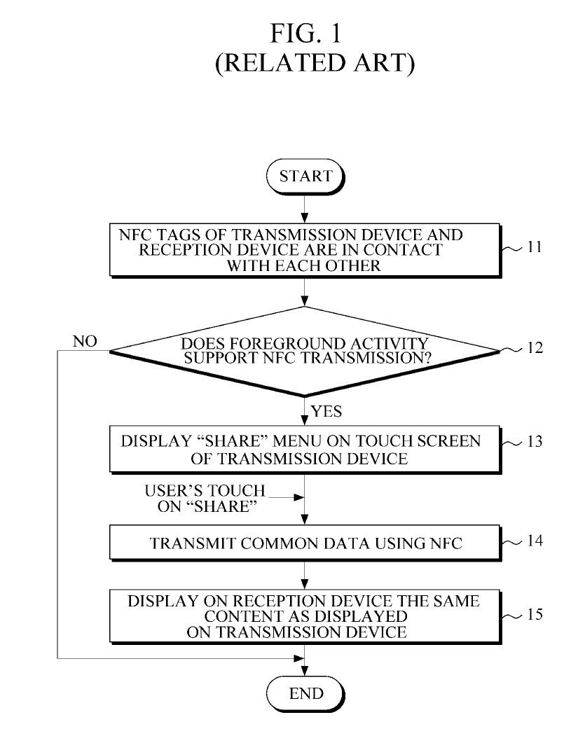

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

Hereinafter, a device may include, without limitation, a transmission device and a reception device. The device may be mobile or stationary, however, the device may be described as a mobile device throughout for ease of disclosure. The transmission device may execute content and transmit common data to another mobile device, such as the reception device, to share the content of the transmission device. The reception device may receive the common data transmitted by the transmission device and execute the same content. The transmission device and the reception device may transmit and receive the common data via peer-to-peer (P2P) short-range wireless communication, and each device may become a peer device of the other device. However, aspects of the invention are not limited thereto, such that the transmission device may also receive content, and the reception device may also transmit content.

The common data may refer to data transmitted to the reception device from the transmission device according to a predefined P2P short-range wireless communication protocol for sharing the content. As will be described later, the common data may include, without limitation, content data related to a target content selected for sharing, and type data containing information about programs executing the content data. More specifically, the type data may refer to types and/or identification information of the programs executing the content data. The content data may be content itself (e.g., text, a telephone number, an email address, multimedia files, such as video and music files, document files, a home screen of a mobile device, and the like) or access information (e.g., information about a web-browser and a uniform resource locator (URL) address of a blog, or information about a path to a web-storage), which may allow access to the content. More particularly, for multimedia files, the content data may be one or more multimedia files itself or a list (e.g., a playlist) of a number of multimedia files. For a home screen of a mobile device, the content data may be files corresponding to elements constituting the home screen and/or the configuration or arrangement in the home screen. In addition, there is no limitation in the type data. For example, Android® operating system (OS) may, without limitation, have a mimeType as the type data.

Hereinafter, the descriptions of exemplary embodiments are provided, which may illustrate an operation in which a Near Field Communication (NFC) link between mobile devices may be first set up for content sharing operation. NFC may be one of short-range communications schemes. In the following description, the short-range communication may refer to a radio communication scheme that enables mobile devices to communicate with each other within a close or reference proximity. More specifically, the mobile devices may communicate over a link, which may be established therebetween when the mobile devices satisfy one or more predetermined physical conditions. Here, the physical conditions may include a situation in which the two mobile devices, being equipped with NFC tags, are in contact with each other or in which the two mobile devices are placed within a reference distance of each other. Such short-range communication may be different from other radio communication schemes (.g., Bluetooth®, Wi-Fi Direct®, etc.) in which a mobile device may preliminarily search for other mobile devices to set up a link to exchange a request message and a response message with the other mobile device.

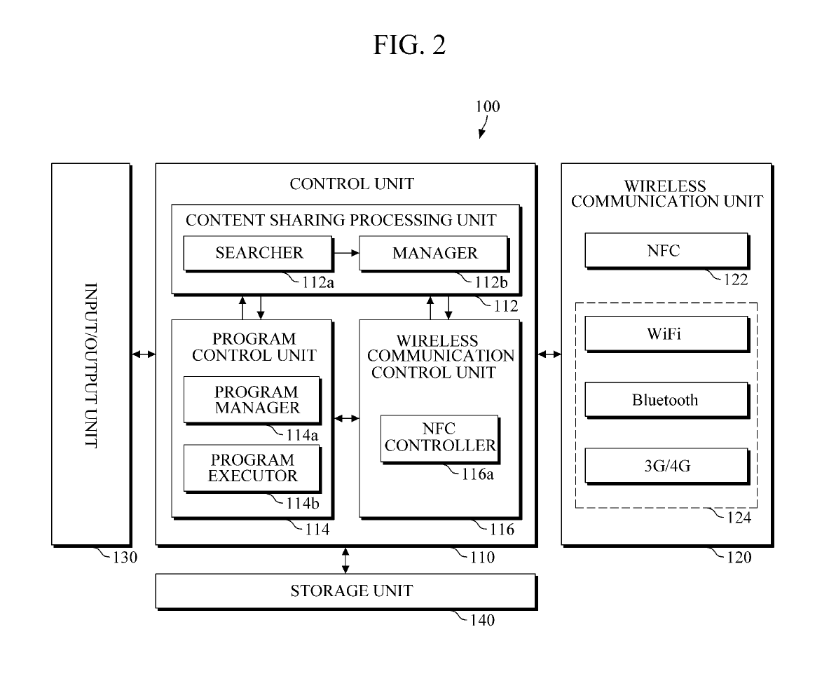

FIG. 2 is a block diagram illustrating a configuration of a device capable of sharing content according to an exemplary embodiment of the present invention.

The mobile device 100 shown in FIG. 2 may be a mobile device equipped with a predefined mobile operating system (OS), such as Android®, iOS®, Windows Mobile® and the like. The OS of the mobile device 100 may be used to control the mobile device 100 and to instruct and set the processing of applications. Hereinafter, the mobile device equipped with Android® as its mobile OS will be described, however, aspects of the invention are not limited thereto, such that mobile OSs other than Android® may be used.

The mobile device 100 equipped with the mobile OS may support multi-tasking. More specifically, the mobile device 100 may be capable of executing multiple programs simultaneously or in conjunction. One of the simultaneously executed programs may be running on a foreground, and the rest of running programs may be running on a background. Generally, content related to the foreground running program is outputted on a display of the mobile device 100.

Here, a program may refer to a software for the mobile device 100 to provide a given service or function. The program may include applications, always-on-top (AOT) applications, and service entities. The unit constituting the program may be referred to as a component and if the component is in the form that may be displayed on a screen, the component may be referred to as a window. The component may be named differently based on the type of OS, for example, the component may be referred to as an activity in the Android® OS and may be referred to as an user inter face (UI) view in the iOS®.

According to exemplary embodiments described herein, the content to be shared between the transmission device and the reception device may be associated with one or more components. For example, a file, such as a music file, a video file, and a document file, may constitute a part of content, which may be associated with the component. In addition, a part of a webpage or a part of an image may constitute a part of content, which may be associated with the component. More specifically, a part of the content may become a target of sharing, if the webpage or the image can be divided into separate parts. For example, if the particular content of a webpage is to be shared or if a part of document is to be shared, the corresponding content may be specified or copied and stored in a clipboard and the NFC tagging, which will be described later, may be performed on the specified part. The content may be specified by, for example, dragging relevant part or parts to be selected as a block.

The mobile device 100 may include at least one of an NFC tag and an NFC chip. The mobile device 100 may support data communication with other mobile devices via NFC. For example, the mobile device 100 may be, without limitation, a smart phone or a table computer, which may include at least one of an NFC tag and an NFC chip. In addition, the mobile device 100 may be a mobile device, for example, a portable multimedia player (PMP) or a navigation device, which may be equipped with a mobile OS and include at least one of an NFC tag and an NFC chip.

Referring to FIG. 2, the mobile device 100 includes a control unit 110, a wireless communication unit 120, an input/output unit 130, and a storage unit 140. The control unit 110 includes a content sharing processing unit 112, a program control unit 114, and a wireless communication control unit 116. The content sharing processing unit 112 includes a searcher 112a, and a manager 112b. The program control unit 114 includes a program manager 114a, and a program executor. The wireless communication control unit 116 includes an NFC controller 116a. The wireless communication unit 120 includes an NFC module 122, and a wireless communication module 124. The wireless communication module 124 includes modules to perform Wi-Fi® communication (e.g., Wi-Fi Direct®), Bluetooth® communication, and mobile communication (3G/4G).

FIG. 2 illustrates an exemplary configuration of a device capable of sharing content with other devices. However, aspects of the invention are not limited thereto, such that the mobile device 100 may not illustrate all modules in FIG. 2 and may omit one or more modules. Further, various components may be integrated together and/or arranged to have a different configuration. For example, the wireless communication unit 120 of the mobile device 100 may include only an NFC module 122 and further include all or part of a wireless communication module 124. In addition, the mobile device 100 may further include additional modules for its operation, and the additional modules may differ according to the type or operation of the mobile device 100. For instance, the mobile device 100 may further include, without limitation, at least one of a sensor module, such as a gravity sensor and/or an acceleration sensor, a vibration generation module, a global positioning system (GPS) module, a digital multimedia broadcasting (DMB) module, a camera module, and the like.

The control unit 110 may perform overall management, processing, and control for the operation of the mobile device 100. For example, the control unit 100 may perform a predefined process in response to a user input signal or request signal. In addition, the control unit 110 may control the input/output unit 130 to output a result of processing the input signal or an execution result of the control unit 110.

The control unit 110 may perform control or signal processing in an effort to enable the mobile communication 100 to communicate with a server or another mobile device for data transmission/reception or for performing a calling operation.

The wireless communication control unit 116 may control or communicate with individual communication modules (e.g., the NFC module 122, a Wi-Fi module, a Bluetooth® module, and a mobile communication (3G/4G) module) included in the wireless communication unit 120, and process signals transmitted and received via the communication modules. Although not illustrated, the wireless communication unit 120 is not limited thereto and may include additional modules, such as a Zigbee® module.

The configuration of the wireless communication control unit 116 may vary corresponding to the configuration of the wireless communication unit 120. Since the wireless communication unit 120 includes at least the NFC module 122, the wireless communication module 116 may include at least an NFC controller 116a for controlling and processing a signal of the NFC module 122, as described later. In addition, if the wireless communication unit 120 includes one or more different types of wireless communication modules 124, the wireless communication control unit 116 may further include other control units (e.g., a Bluetooth® control unit and the like) for controlling the respective control units.

Further, the control unit 110 may execute a predetermined program within the mobile device 100 to play games and to access the Internet. Further, the control unit 110 may perform control operation and signal processing to manage the running program. The mobile device 100 may run one or more programs at the same time. To execute and manage one or more programs, the control unit 110 may include a program control unit 114 to include a program manager 114a and a program executor 114b. The program manager 114a may manage a program running in the mobile device 100 and components of the program. In addition, the program executor 114b may execute various programs installed in the mobile device 100. More particularly, the program executor 114b of the reception device may execute a predetermined program with reference to type data contained in the received common data, thereby allowing the same component as that of the transmission device to be executed in the reception device.

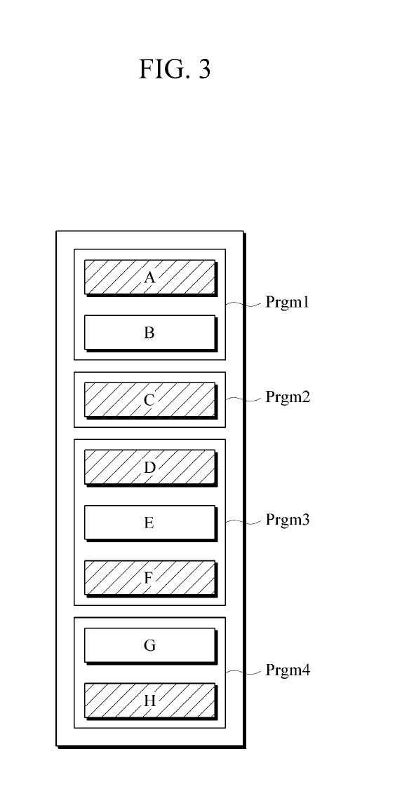

FIG. 3 is a diagram illustrating a program stack and component stacks of each program executed in a device according to an exemplary embodiment of the present invention.

The program stack conceptually shows an execution status of one or more programs running in the mobile device 100, and the component stack conceptually shows an execution status of the components executed in one or more programs. Referring to FIG. 3, in the program stack, four programs, which may be simultaneously running, are sequentially arranged in a stacked structure according to the execution order. In addition, in the component stack of each program, the components that have been executed or are being executed are arranged in a stacked structure according to the execution order. More specifically, program Prgm 4 may be executed first, program Prgm 3 may be executed second, program Prgm 2 may be executed third, and program Prgm 1 may be executed fourth or most recently. However, aspects of the invention are not limited thereto, such that the programs may be stacked in a reverse order or based on different criteria. Further, referring to FIG. 3, in the four programs that are currently running, one to three components among components A, B, C, D, E, F, G, and H may be been executed in each program. More specifically, component A, among components A and B included in the program Prgm 1 may have been executed.

The shaded components A, C, D, F and H in FIG. 3 may be components supporting the content sharing operation according to exemplary embodiment of the present invention. The remaining components B, E, and G may be components that do not support the content sharing operation. The components supporting the content sharing operation may be components associated with one or more contents, such as components having information, which may include information about a path (e.g., an access path or a storage path) to target content and content identification information (e.g., content's name). Whether the component may support the content sharing operation may be predetermined by, for example, a manufacturer or the mobile device and/or a program provider. In the Android® OS, a component of a program including a function for performing a given operation, more specifically, an activity of an application, may support the content sharing operation.

In addition, according to aspects of the invention, a program at a higher position in the program stack may refer to a more recently executed program, and within the component stack of each program, a component at a higher position may refer to a more recently executed component. Accordingly, in the program stack shown in FIG. 3, program Prgm1 may be the most recently executed program, which may be running in a foreground, and the rest of the programs, Prgm 2, Prgm3, and Prgm 4, may be being running in the background. In addition, component A of program Prgm1, which is placed higher than component B of program Prgm1, may be more recently executed than component B. Thus, in the program stack shown in FIG. 3, content associated with the current component A may be outputted on a display of the mobile device 100 or appearing in the foreground of the display (e.g., if the mobile device 100 is capable of displaying multiple windows).

In addition, the control unit 110 may include a content sharing processing unit 112 to provide overall control and to process a signal to allow the mobile device 100 to perform operations of either the transmission device or the reception device to share the content with other mobile devices. The detailed operation of the content sharing processing unit 112 may differ according to whether the mobile device 100 is a transmission device or a reception device. More specifically, the content sharing processing unit 112 of the transmission device may search for components of programs currently executed in the foreground and the background, compiles a list of the found components and display the list, and controls the transmission of common data for performing a sharing content operation of a source component to the reception device via a predefined P2P short-range wireless communication. Such operation of the content sharing processing unit 112 of the transmission device may be performed if an NFC link between the transmission device and the reception device is established. In addition, the content sharing processing unit 112 of the reception device may communicate with the program control unit 114 using the received common data to communicate and to execute a component of the same program as a program of the transmission device, more specifically, the source component.

Generally, the content sharing processing unit 112 may be configured to perform both functions of the transmission device and the reception device as described above, and may not have any limitations in configuration details. Further, as shown in FIG. 2, the content sharing processing unit 112 includes the searcher 112a and the manager 112b. In addition, functions of the searcher 112a and the manager 112b, which will be described later, may be distinguished in terms of logical process, and each unit may be physically integrated into one body or physically separated. Further, a part of the function of one unit (e.g., the manager 112b) may be performed by another unit (e.g., the searcher 112a) or by an additional unit. Hereinafter, with reference to FIG. 2, the function of the content sharing processing unit 112 will be described in more detail.

The searcher 112a may search for components currently being executed in the mobile device 100. More specifically, the searcher 112a may search for components of the programs being executed in the foreground and the background of the mobile device 100. The searcher 112a may search for the components of some or all programs currently being executed or may selectively search for components of the programs that may support the content sharing operation from among the programs being currently executed. In the former case, the manager 112b may choose the components that support the content sharing operation from the found components.

As described above, the component supporting the content sharing operation may have information, which may include a path to target content and identification information, and may be predefined by a manufacture of the mobile device and/or a program provider. Under the Android® OS, an activity of an application including a function for executing a related operation may be able to support content sharing operation, and it may be possible to determine whether the activity supports the content sharing operation by using properties information, such as manifest, of the corresponding application. Further, it may be determined by the searcher 112a or the manager 112b whether a component supports content sharing based on predefined criteria.

According to exemplary embodiments of the present invention, the searcher 112a may search for the components of the programs currently being executed in the foreground and the background, using various methods without limitation. For example, the searcher 112a may receive information about programs and/or components of each of the programs being currently executed in the foreground and the background from the program manager 114a (e.g., information about the program stack and the component stack shown in FIG. 3). Further, the searcher 112a may search for all or some of components of one or more of the currently executed programs. As an example of the latter case, the searcher 112a may search for the top component or the most recently executed component of each of the currently executed programs (e.g., the top component of each program in the component stack shown in FIG. 3). Alternatively, the searcher 112a may search for some or all components supporting content sharing operation or the top component or the most recently executed component with respect to its program supporting the content sharing operation, from among the components of the currently executed programs. The searcher 112a operates as described above when the mobile device 100 is a transmission device, and the searcher 112a may not perform any particular operations when the mobile device 100 is a reception device.

The manager 112b may operate differently when the mobile device 100 is a transmission device versus when the mobile device 100 is a reception device. Where the mobile device 100 is a transmission device, the manager 112b may control to create a component list including all or some of the components found by the searcher 112a and to output the component list through the output module of the input/output unit 130. For example, the component list created by the manager 112b may selectively include components supporting content sharing operation, from among the components found by the searcher 112a, and exclude components that do not support the content sharing operation. Further, the component list may include some or all components found by the searcher 112a while distinguishing the components that support content sharing operation and the components that do not (e.g., by activating or highlighting the components supporting the content sharing operation). Where the searcher 112a may search for components supporting the content sharing operation, the component list created by the manager 112b may include some or all components found by the searcher 112a. As such, one or more components (or associated content) that may be targets of sharing operation may appear on the display as items on a component list, and a user may be able to confirm and/or select the desired component (or content).

Further, according to exemplary embodiments of the present invention, the component list may be displayed not on the transmission device but on the reception device. If the component list is to be displayed on the reception device, the transmission device may have previously transmitted the component list to the reception device. Accordingly, a user of the reception device may be able to select a component (or content) as a target of a sharing operation.

In addition, the manager 112b may determine a transmission method, which may be used to transmit common data of the selected component, more specifically, a source component, to the reception device. In the reception device, the component may be selected when the user's input is received through an input module of the input/output unit 130 to select one or more components from the component list shown on the display. Here, the transmission method may indicate or refer to wireless communication standard types (e.g., wireless communication protocols) used for the transmission device to transmit the common data to the reception device. Further, the manager 112b may have access to information about a type of the P2P short range communication supported by the peer device, which may seek to share the content. However, if the transmission method has been previously determined according to a type of content to be shared or if the common data is transmitted by a particular transmission method, the manager 112b may not determine a transmission method.

According to aspects of the invention, both the transmission device and the reception device may support NFC and a number of P2P short range wireless communications (e.g., Bluetooth®, Wi-Fi Direct®, and the like). Further, the manager 112b may determine the transmission method based on the capacity of the common data to be transmitted to the reception device. For example, if the capacity of common data or content is determined to be smaller in size or below a reference threshold, more specifically, if the data is small enough to be transmitted as an NFC message, the manager 112b may determine the transmission method as NFC. If the common data to be transferred is larger in size or above a reference threshold, the manager 112b may determine the transmission method as a wireless communication scheme, such as Wi-Fi Direct® and Bluetooth®, which can support larger capacity data transmission. The capacity or size of common data as a criterion for determining a type of the transmission method may be determined based on a transmission capacity of NFC. This may be because while the NFC may provide a simpler process in transmitting data due to lack of additional procedure that may be performed for setting up a link between devices, the transmission capacity may be smaller than other wireless communication technologies. Accordingly, it may be appreciated by those skilled in the art that as the transmission capacity of the NFC increases with the development of the technology, the criterion specification (e.g., the capacity of common data) for determining the transmission method may vary.

For example, if a size of the common data of the source component is below a reference transmission capacity, more specifically, if content data is text data (e.g., contact information, webpage access path information, and the like), which may be smaller in data size or capacity, the manager 112b may determine the transmission method as NFC. If the content data to be transmitted is a multimedia file (e.g., music or video) or a document file above a reference data size threshold, which may be larger in data size or capacity, the manager 112b may determine the transmission method to be used as Bluetooth® or Wi-Fi Direct®.

Further, the manager 112b may determine the transmission method based on at least one of a storage location of content to be shared and a type of the content. For example, if corresponding content is stored in a server and a storage path to the content is easily recognized, thereby enabling easy access to the content (e.g., a webpage), or if the corresponding content is stored in the transmission device and is content, such as text, (e.g., contacts) which may inherently have a smaller capacity, the transmission method for the content may be determined as NFC. If a corresponding content file is stored in the transmission device and the content (e.g., currently played music, an image, a video, or document) that may have a larger data size, the transmission method to be used may be determined as Wi-Fi Direct® or Bluetooth®.

The manager 112b may determine the transmission method based on the user's intent. The user may use the transmission device and/or the reception device. Further, the mobile device 112b may additionally include a configuration (e.g., a user interface and a function module for processing the user interface) to receive the user's content.

Further, according to aspects of the invention, the manager 112b may control essential data of smaller capacity or below a reference threshold size, among the common data, to be configured to be transmitted via NFC on a regular basis. For example, the manager 112b may control or configure type data among the common data and transmission method information, which will be described later, to be transmitted from the transmission device to the reception device via NFC by default. The type data may be transmitted, along with target content data, by the same transmission method as the method of the target content. However, aspects of the invention are not limited thereto, such that the common data of small capacity may be transmitted according to P2P short-range wireless communication protocols other than NFC.

In addition, the manager 112b may control or configure information indicating the determined transmission method (hereinafter, referred to as transmission method information) to be transmitted to the reception device via NFC. This may be because the reception device may request to receive the determined transmission method in advance to choose an appropriate communication method. In further example, the manager 112b may transmit information (e.g., Media Access Control (MAC) address of the transmission device) of the transmission device via NFC, in which the information may be requested for setting up a link to the reception device according to the determined transmission method. This may be because NFC can set up a link between the transmission device and the reception device by tagging, whereas the other P2P transmission method (e.g., Bluetooth® or Wi-Fi Direct®) may request identification/recognition information, such as MAC addresses of each peer, to set up a link.

In addition, the manager 112b of the transmission device may communicate with the wireless communication control unit 116 to transmit the common data of the source component according to the determined transmission method. For example, the transmission method may be determined as NFC, the manager 112b of the transmission device may deliver a transmission request signal to the wireless communication control unit 116, more particularly, the NFC controller 116a.

In addition, the NFC controller 116a may transmit the common data through the NFC module 122. If the transmission method is determined as one of the other P2P short-range wireless communication method other than NFC, the manager 112b of the transmission device may deliver the transmission request signal to the wireless communication control unit 116 including the NFC controller 116a. Further, the NFC controller 116a may transmit part of common data (e.g., type data and/or content data below a reference size or of small capacity) through the NFC module 122, and the wireless communication control unit 116 may transmit the remaining common data (e.g., content data above a reference size or of large capacity) through other wireless communication modules 124.

In response to receiving the common data through the wireless communication unit 120, the manager 112b of the reception device may execute a component of the same program as that of the transmission device using the received common data. For example, the manager 112b of the reception device, which may have received the common data, may communicate with the program control unit 114, more particularly, the program executor 114b, to initiate the execution of the component of the same program as the program of the transmission device. Further, the program executor 114b may select a proper program with reference to the type data contained in the common data. The content data contained in the common data may become content that constitutes a component of a program to be executed, or may be utilized as access information (e.g., a webpage) used in accessing the content, as described above.

The wireless communication unit 120 may transmit and receive electromagnetic waves to communicate over a wireless communication network and/or to communicate, either directly or indirectly, with other mobile devices. The wireless communication unit 120 includes the NFC module 122, and a wireless communication module 124, which may include modules corresponding to other wireless communication protocols (e.g., Wi-Fi®, Bluetooth®, and 3G/4G). However, aspects of the invention are not limited thereto, such that the types and number of the different wireless communication modules included in the wireless communication module 124 may accommodate other wireless communication protocols. The other wireless communication protocols that may be accommodated by the wireless communication module 124 may include a P2P short-range communication protocol, such as Zigbee® and Wi-Fi Direct®.

The input/output unit 130 may be provided to input data and a signal to the mobile device 100 or to output data and signal processed by the mobile device 100. More specifically, the input/output unit 130 may include a camera unit to input an image/video signal, a microphone to input voice or sound, an input device, such as a key pad, a dome switch, a button, a jog wheel, and a touch pad, which may enable the user to input data and instructions to the mobile device 100, and an outputting device, such as a display for outputting a video signal, and a speaker for outputting an audio signal.

The input/output unit 130 may include a touch screen. The touch screen may be an example of an input/output device, which may allow interaction between the user and the mobile device 100, and may incorporate a touch pad as an input unit and a display as an output unit. The touch screen may have a stacked structure in which the touch pad as an input unit and the display as an output unit are coupled to each other, or have a integrated structure in which the touch pad and the display may be integrated into one device. The user may touch, directly or with a stylus pen, a touch screen to input an instruction or information to the mobile device 100. The mobile device 100 may output information, such as text, an image, and/or video through the touch screen, enabling the user to view the outputted information.

The storage unit 140 may store computer programs used for management and operation of the mobile device 100. More specifically, the memory 140 may store a variety of computer programs, such as OS programs, a number of function module programs, and application programs, for the control and management of the control unit 110. Additionally, the storage unit 140 may store data and information, such as e-mails, text, images, videos, documents, music files, phone numbers, call history, and messages. The storage unit 140 may include various types, and may include random access memory (RAM), and internal or external flash memory, magnetic-disk memory, and read only memory (ROM).

Hereinafter, a method for sharing content between mobile devices according to exemplary embodiments of the present invention will be described. The method of sharing content between mobile devices may be performed by the mobile devices including the content sharing processing unit, which is described above with reference to FIG. 2 and FIG. 3, however, aspects of the invention are not limited thereto.

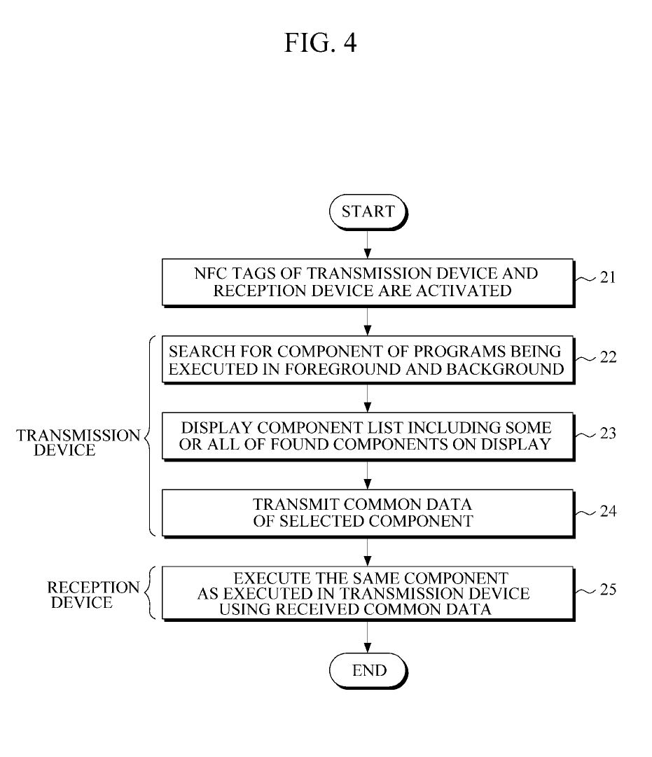

FIG. 4 is a flowchart illustrating a method for sharing content between devices according to an exemplary embodiment of the present invention.

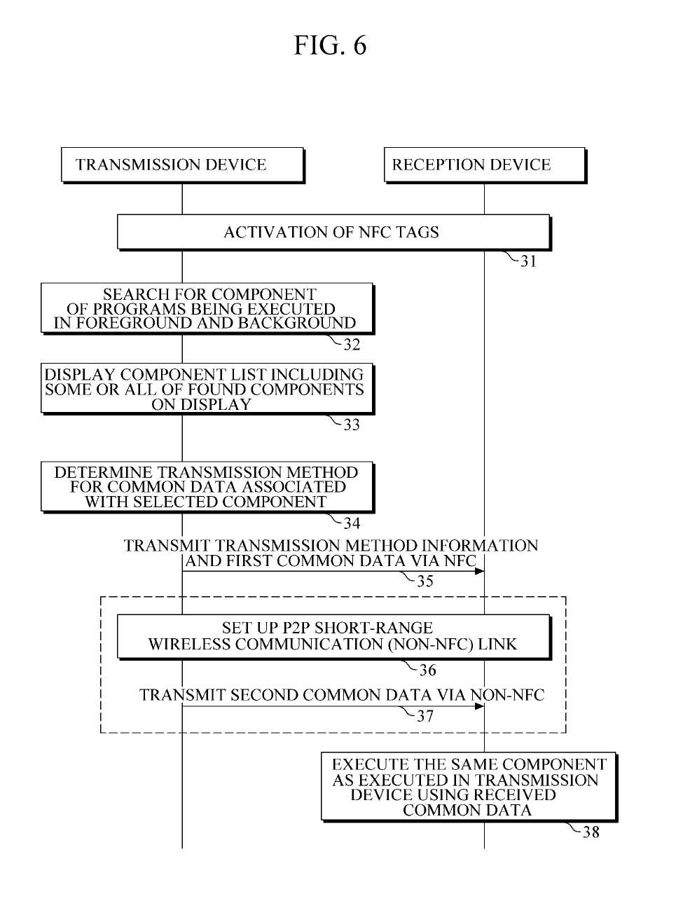

Referring to FIG. 4, common data, such as type data and content data, may be transmitted via NFC, and not through P2P short-range wireless communication. In addition, the flowchart of FIG. 4 illustrates one piece of content being shared at a time, more specifically, common data associated with one component being transmitted at one time. However, aspects of the invention are not limited thereto, such that a number of components may be transmitted. If a number of components is to be transmitted, as illustrated in FIG. 6, an additional procedure for the user to select the components and also an interface for the additional procedure may be provided.

Referring to FIG. 4, two devices, such as the transmission device and the reception device having NFC tags, to share content with each other, are in contact with each other in operation 21. This operation may be an exemplary procedure for the transmission device and the reception device to recognize each other as peers and set up a link for NFC communication. Thus, if the transmission device and the reception device can set up an NFC link through a different procedure, other than having devices equipped with the NFC tags physically contacting each other or being disposed within a reference proximity of one another, it may be possible to substitute the procedure for operation 21.

When the devices equipped with NFC tags contact each other or when the NFC tags become activated, operations 22, 23, 24 and 25 performed by the transmission device and the reception device may be implemented by various methods. For example, when the transmission device and the reception device execute a predetermined program (e.g., a program for sharing content) or a user menu and perform operation 21, the process flow proceeds to the content sharing procedures, including operations 22, 23, 24 and 25. Further, once operation 21 has been performed, the process flow may proceed directly to the content sharing procedures (i.e., operations 22, 23, 24 and 25), regardless of meeting any conditions.

If the NFC link to the reception device has been established by the transmission device, the transmission device may search for components of programs that are currently executed in both a foreground and a background in operation 22. As described above, operation 22 may be performed by the searcher 112a of the content sharing processing unit 112 included in the transmission device, which may communicate with the program manager 114a (see FIG. 2). The searcher 112a may selectively search for, for example, components supporting content sharing operation. One or more components may indicate whether the component supports the content sharing operation. The searcher 112a uses the definition to find an activity that may support the content sharing operation, but the searching process is not limited thereto. Further, the searcher 112a may perform searching process, regardless of whether one or more of the currently executed components support content sharing operation or not, such that the component list found in operation 23 may include components that do not support content sharing. The searcher 112a may search for some or all components of the programs being currently executed or the top component in each program, as described above.

In operation 23, a component list that distinguishingly shows the components supporting content sharing operation and the components that do not among the components found in operation 22 is displayed on a display of the transmission device. Operation 23 may be performed by the manager 112b of the content sharing processing unit 112. When the contents that support content sharing operation are found in operation 22, the manager 112b may output a component list including some or all found components through the output module of the input/output unit 130. For example, the component list may be displayed on a touch screen of the transmission device.

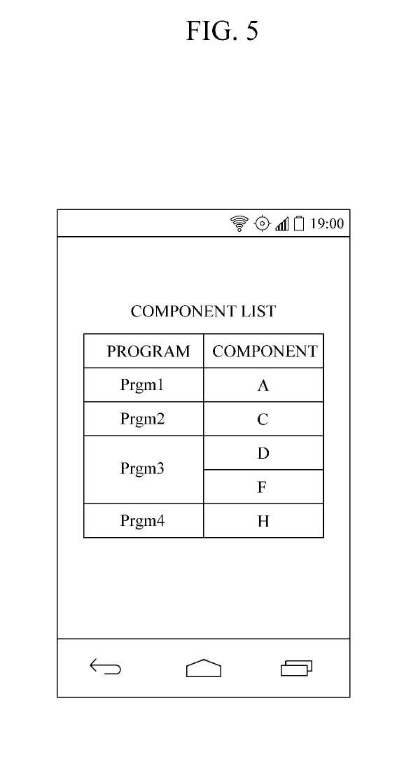

According to aspects of the invention, a method of displaying the component list on the display in operation 23 is not limited to as described above. For example, if a program execution state of the mobile device 100 is the same as the program stack and the component stack illustrated in FIG. 3, the component list may be displayed in a form of table including text on the display, as shown in FIG. 5. However, aspects of the invention are not limited thereto, such that the component list may be in the form of table including screen images, as well as text, or be in various forms that facilitates user's recognition of content of each component.

Referring back to FIG. 4, the manager 112b of the transmission device transmits common data of a component chosen by the user, such as a target component, to the reception device in operation 24. The user may select one of the components from the component list displayed in operation 23. As described above, operation 24 may apply when a plurality of components are selected and transmitted. In operation 24, the common data of the target component that is selected by the user is transmitted to the reception device. If the component list is displayed on the touch screen of the mobile device 100, the user may select a component to be transmitted by touching it from the component list displayed on the touch screen. In response to detecting a user's selection signal on the touch screen, the manager 112b may communicate with the wireless communication control unit 116, more specifically, the NFC controller 116a, to transmit the common data of the selected component.

The user's input for executing the transmission of the common data from the transmission device to the reception device and the user interface to receive the user's input may be implemented in various ways. For example, the mobile device may recognize a predefined motion (e.g., a movement to the reception device) as a user's input by utilizing a gyro sensor and/or an acceleration sensor equipped in the mobile device. For another example, when the user selects the content to be shared (e.g., a long click on the content), a pop-up menu for the user to input a transmission request may appear on the display. Further, in response to the user's touching the pop-up menu, the common data may be transmitted to the reception device.

As described above, in operation 24, the common data may be transmitted through the NFC module 122, and the P2P wireless communication module 124 may not be used for transmitting the common data. As described above, the common data includes at least one of type data and content data, in which the content data may be data below a reference size, such as a text of small capacity or access path information. Further, the type of content as a target of sharing operation may be the same as that of the existing method, for example, Android Beam® offered by Android® OS.

In operation 25, the reception device executes the same component as the component of the transmission device using the received common data. The manager 112b of the reception device may determine a program to be executed with reference to the type data contained in the received common data, and transfer information about the determined program to the program executor 114b. Further, the program executor 114b may execute a component of the program, which may have been determined by the manager 112b, using the content data contained in the received common data. As a result, the display of the reception device may display the same content currently appearing on the display of the transmission device when sharing content associated with the component being executed in the foreground, or the same content that has previously appeared on the display of the transmission device when sharing content associated with the component being executed in the background. If in operation 24, the selected components and pieces of common data associated with the respective selected components are transmitted to the reception device, the user may select a component of the program to be executed in operation 25.

At least for these reasons, the method of sharing content according to exemplary embodiments of the present invention may be distinguished from a content sharing method in a related art. For example, in operation 22, the components (e.g., content) of the programs executed in the foreground and also the components of the programs executed in the background become a target of a sharing operation. According to exemplary embodiments of the present invention, a component in a foreground or the utmost foreground may not be executed when the component indicates content to be shared, and it may be possible to share content of the component that is being executed in the background or behind the foreground.

For example, when the transmission device executes an Internet browser in the foreground and is running a contact program in the background, only a webpage that is executed in the foreground of the transmission device and thus currently being displayed on a screen can be a target of content sharing operation with the reception device according to a related art. However, according to exemplary embodiments of the present invention, content (e.g., webpage) of a browser currently executed in the foreground and also the contact information running in the background can become a target of content sharing operation.

FIG. 6 is a flowchart illustrating a method for sharing content between devices according to an exemplary embodiment of the present invention.

The method of FIG. 6 illustrates a situation where it is possible to share one or more pieces of content at a time (i.e., when common data associated with one or more pieces of components is transmitted), in which some common data (hereinafter, referred to as first common data) is transmitted through an NFC module but the remaining common data (hereinafter, will be referred to as second common data) is transmitted through other P2P short-range wireless communication (i.e., non-NFC) modules.

Distinguishing between the first common data and the second common data may be made based on various criteria, such as size or type of each data. For example, the first common data may contain a first type data of some or all components, and the second common data may contain a second type data of some or all components. Further, the first common data may contain small capacity content data (e.g., text or access path information) or data below a reference threshold size, and the second common data may contain larger capacity content data (e.g., an image file, a music file, a video file, and a document file) or data above a reference threshold size. Further, the first common data may include common data containing content data of smaller capacity among the common data associated with one or more components (e.g., the first common data that includes both type data and content data), and the second common data may include common data containing content data of larger capacity among the common data associated with one or more components.

In addition, referring to FIG. 4 the transmission method information, which may be transmitted via NFC, may indicate whether each data (e.g., content data) is to be transmitted via NFC or P2P short-range wireless communication (hereinafter, referred to as “non-NFC). However, aspects of the invention are not limited thereto, and the transmission method information may be transmitted as a part of common data, instead of being transmitted separately from the common data, or type data contained in the common data. If it is predetermined whether content data is to be transmitted via NFC or non-NFC according to the type of content, the type data may act as the transmission method information, and the transmission method information may not be separately transmitted.

Referring to FIG. 2 and FIG. 6, in operation 31, two devices to share content, more specifically, the transmission device and the reception device equipped with NFC tags, are in contact or within a reference proximity of each other. By doing so, the transmission device and the reception device may be able to recognize each other and set up an NFC link to conduct NFC communication. However, aspects of the invention are not limited thereto, such that if the NFC link setup can be performed by a different procedure other than described above, it may be possible to substitute the procedure for operation 31.

In operation 32, in response to detecting the contact with the reception device by the transmission device, both of which may be equipped with NFC tags, the transmission device searchers for components of programs being currently executed at least in one of the foreground and the background. As described above, the searcher 112a of the content sharing processing unit 112 in the transmission device may perform operation 32 by communicating with the manager 114a (see FIG. 2). The searcher 112a may perform a searching operation, regardless of whether the currently executed components support content sharing operation or not. For example, the searcher 112a may search for some or all components of the program being currently executed, such as recently executed components.

Then, in operation 33, a component list made from the components found in operation 32 is displayed on the display. The component list may include the components that support content sharing operation or distinguishingly display the components that may support content sharing operation and the components that do not. Operation 33 may be performed by the manager 112b of the content sharing processing unit 112. If only the components that support content sharing operations are found in operation 32, the manager 112b may output the component list including some or all found components through an output module of the input/output unit 130, as described above.

In addition, referring to operation 33, a method of displaying the component list on the display may not be executed in various ways. For example, operation 23 shown in FIG. 4 may be applicable to operation 33. Thus, the component list illustrated in FIG. 5 may be used in operation 33. However, in the exemplary embodiment of FIG. 6, there may be multiple pieces of target content to be shared, and a user interface (UI) to accommodate the multiple target content may be implemented in the component list appearing on the touch screen.

For example, a selection box (e.g., a symbol for allowing the user to select corresponding component by touching the symbol once, and to unselect the component by touching it again) with a name of one or more components included in the component list may be displayed on the touch screen. More specifically, referring to FIG. 5, the selection box may appear next to a name of each component. Further, the UI may be implemented to allow selection of multiple choices of items of the components, which may support content sharing operation or items of the components constituting the component list may be feasible. However, according to aspects of the invention, an additional menu to receive an input selection may be displayed on the touch screen.

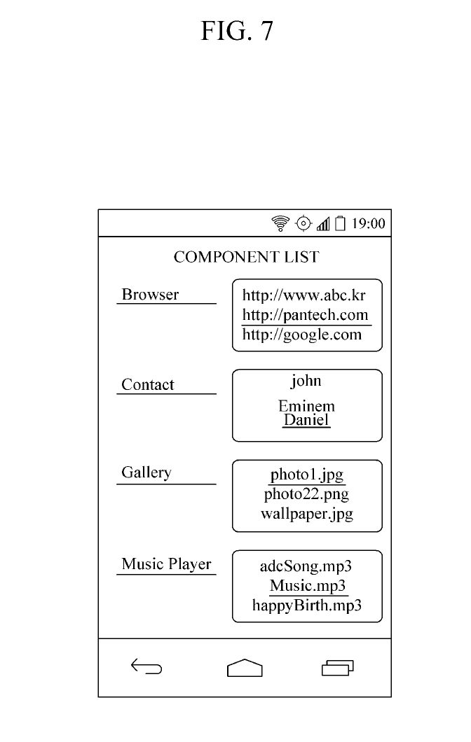

FIG. 7 is a diagram illustrating a component list appearing on a display of a transmission device according to an exemplary embodiment of the present invention.

Referring to FIG. 7, the component list show, as a result of operation 33, that four programs, including Browser, Contact, Gallery, and Music Player, each have three components or files for a total of 12 files that support content sharing operation. In FIG. 7, since the files are sorted by categories, the user of the transmission device can more easily find a file to be transmitted. The underlined four files among the twelve files may indicate files that the user has selected. More specifically, the component list shown in FIG. 7 may be configured as a UI that allows the multiple choices.

Referring back to FIG. 6, in operation 34, the manager 112b of the transmission device may determine a transmission method for common data of the component selected by the user or the source component. The user may select one or more components from the component list displayed in operation 33, and in operation 34, a transmission method (e.g., a type of P2P short-range wireless communication) used to transmit common data (e.g., content data) of one or more source components selected by the user to the reception device is determined. Further, based on the capacity or size of content data included in the common data, the transmission method to be used may be determined as NFC or non-NFC. According to a result of operation 34, the common data may be classified into first common data to be transmitted via NFC and second common data to be transmitted through non-NFC. However, if the transmission method is predetermined according to the type of content data, the classification process of the common data can be omitted. Further, the common data may be classified based on the type of content data, and classified into the first common data to be transmitted via NFC and the second common data to be transmitted through non-NFC.

In addition, according to the determined or predetermined transmission method, the transmission device transmits the common data to the reception device in operations 35, 36 and 37. More specifically, the transmission device transmits the first common data to the reception device via NFC in operation 35. Further, transmission method information for transmitting the second common data may be transmitted along with the first common data. In addition, the transmission device may transmit the second common data to the reception device through non-NFC in operation 37. In operation 36, a link between the transmission device and the reception device may be set up to conduct communications with respect to non-NFC protocols. Although operations 35, 36, and 37 are illustrated to be subsequently performed, aspects of the invention are not limited thereto, such that operation 35 may follow operation 37 when the transmission method information is not transmitted. Alternatively, operations 35, 36, and 37 may be performed at the same time.

A method of setting up the non-NFC link for P2P short-range wireless communication between the two mobile devices may be implemented in various ways without limitation. Further, the link setup may be performed according to procedures specified by corresponding P2P short-range wireless communication standards. However, some or all of information (e.g., MAC address of the transmission device) used for setting up the non-NFC link may be transmitted via NFC in operation 35. Accordingly, the reception device may set up more actively or more easily the non-NFC link to the transmission device using the received MAC address of the transmission device.

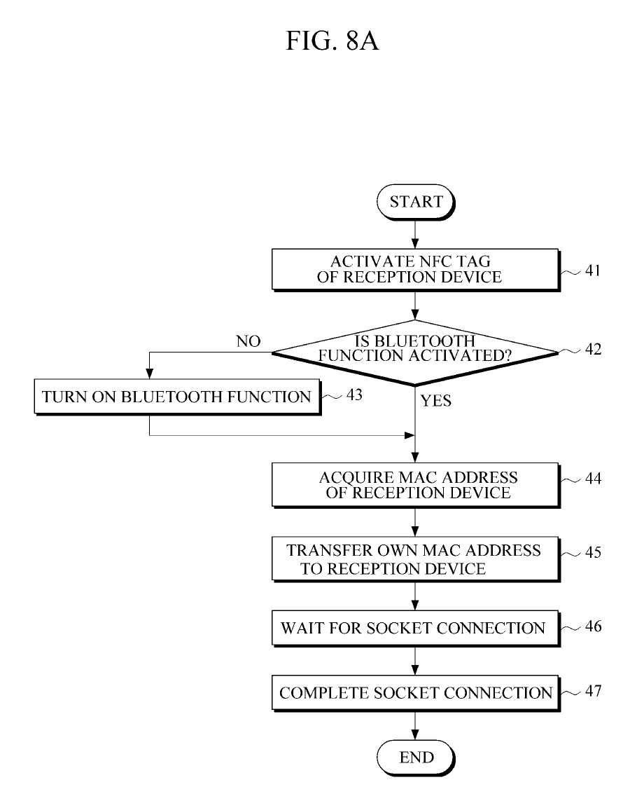

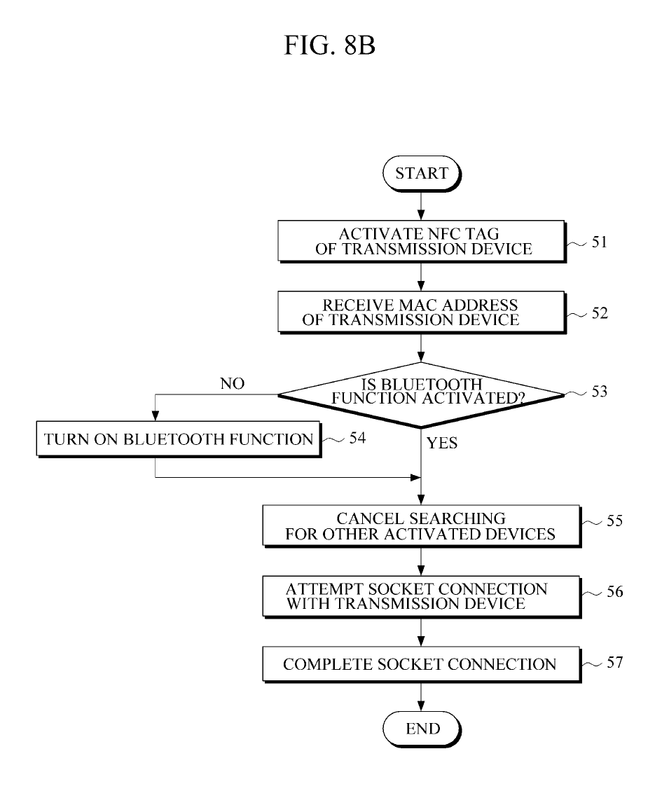

FIG. 8A and FIG. 8B are flowcharts illustrating methods for establishing a non-NFC link between devices according to exemplary embodiments of the present invention. More specifically, the flowchart shown in FIG. 8A may correspond to the transmission device and the flowchart shown in FIG. 8B may correspond to the reception device.

FIG. 8A and FIG. 8B may illustrate a search process that may be performed when the reception device receives MAC address of the transmission device and socket connection is attempted. However, aspects of the invention are not limited thereto, such that the Bluetooth® setup procedures are not limited thereto. Further, it may be appreciated by those skilled in the art that the search process may be performed and socket connection may be attempted when the transmission device receives MAC address of the reception device. In addition, according to aspects of the invention, prior to initialization or activation of the NFC tags, the transmission device and the reception device may set up a Bluetooth® link in advance.

Referring to FIG. 8A, the transmission device and the reception device equipped with NFC tags may be in contact with each other to initialize or activate the NFC tags in operation 41. Operation 41 may be similar to or the same as operation 31 of FIG. 6. In addition, the transmission device checks to determine whether its Bluetooth® function is activated in operation 42. If the Bluetooth® function is determined not to be activated, the transmission device turns on the Bluetooth® function in operation 43. In operation 44, the transmission device with the Bluetooth® function acquires MAC address of the reception device. In operation 45, the transmission device transfers its MAC address to the reception device. If the transmission device transmits its MAC address along with the first common data to the reception device, operation 45 may be omitted, and the transmission of MAC address may be performed as a part of operation 35 of FIG. 6. However, aspects of the invention are not limited thereto, and operation 45 may be performed as one procedure in a general Bluetooth® setup process, regardless of operation 35 of FIG. 6. In operation 46, the transmission device waits for socket connection after transferring the MAC address to the reception device. In operation 47, the socket connection with the reception device is completed.

Referring to FIG. 8B, the reception device and the transmission device equipped with NFC tags may be in contact with each other or may be within a reference proximity to initialize or activate the NFC tags in operation 51. Operation 51 may be similar to or the same as operation 31 of FIG. 6. In addition, the reception device receives MAC address of the transmission device in operation 52. Operation 52 may apply when the transmission device transmits the MAC address as a part of the first common data to the reception device (see operation 35 of FIG. 6 and operation 45 of FIG. 8A). In addition, the reception device may check to determine whether its own Bluetooth® function is activated in operation 53. If the Bluetooth® function is not activated, the reception device turns on the Bluetooth® function in operation 54. The reception device with the Bluetooth® function terminates automatic searching for other activated devices in operation 55. This may allow an attempt to establish socket connection in operation 56. It is appreciated by those skilled in the art that if the search function does not automatically run even when the Bluetooth® function of the reception device is turned on, or if it is permitted to attempt socket connection during search procedure by the Bluetooth® function, operation 55 may be omitted. In operation 56, the reception device attempts to establish a socket connection with the transmission device. In operation 57, the reception device completes the socket connection with the transmission device.

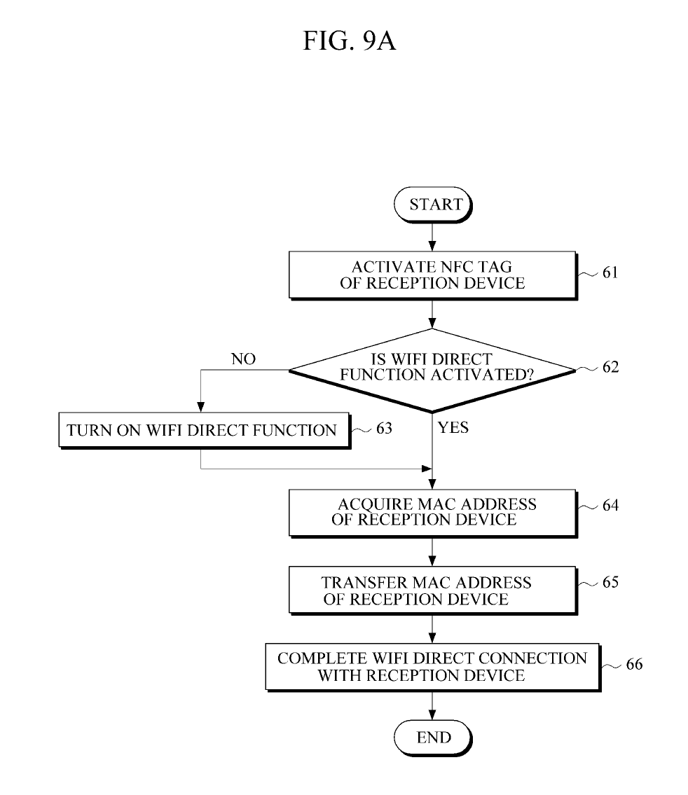

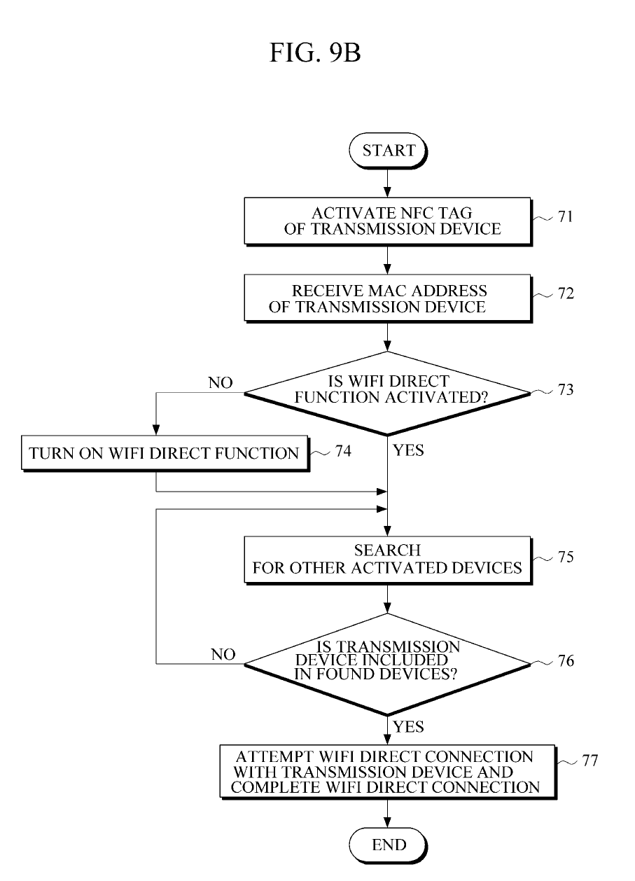

FIG. 9A and FIG. 9B are flowcharts illustrating methods for establishing a non-NFC link, between devices according to exemplary embodiments of the present invention. The flowchart shown in FIG. 9A relates to the transmission device and the flowchart shown in FIG. 9b relates to the reception device.

The procedures illustrated in FIG. 9A and FIG. 9B may apply when the reception device performs a search and attempts to link a setup after receiving MAC address from the transmission device. However, the procedures for setting up a Wi-Fi Direct® link may not be limited thereto. It is appreciated by those skilled in the art that the transmission device may perform a search operation and attempt a link setup when MAC address is received from the reception device. Further, according to aspects of the invention, prior to initialization of NFC tags in at least one of the transmission device and the reception device, the transmission device and the reception device may set up a Wi-Fi Direct® link in advance.

Referring to FIG. 9A, a transmission device equipped with an NFC tag may be in contact with a reception device equipped with an NFC tag to initialize or activate the NFC tags in operation 61. Operation 61 may be similar to or the same as operation 31 of FIG. 6. In operation 62, the transmission device checks to determine whether its own Wi-Fi Direct® function is activated. If the Wi-Fi Direct® function is not activated, the transmission device activates the Wi-Fi Direct® function in operation 63. In operation 64, the transmission device with activated the Wi-Fi Direction® function acquires MAC address of the reception device. In operation 65, the transmission device transfers its own MAC address to the reception device. When the transmission device transmits the MAC address as a part of the first common data to the reception device in operation 35 of FIG. 6, operation 65 may be skipped but performed as a part of operation 35 of FIG. 6, as described above. In operation 66, the transmission device that has transmitted the MAC address to the reception device waits for a Wi-Fi Direct® connection request from the reception device and responds to the request to complete a Wi-Fi Direct® connection with the reception device.

Referring to FIG. 9B, a reception device equipped with an NFC tag may be in contact with or within a reference proximity of a transmission device equipped with an NFC tag to initialize or activate the NFC tags in operation 71. Operation 71 may be similar to or the same as operation 31 of FIG. 6, and operation 61 of FIG. 9A. In operation 72, the reception device receives MAC address of the transmission device. Operation 72 may apply when the reception device receives the MAC address transmitted as a part of the first common data from the transmission device. In operation 73, the reception device checks to determine whether its own Wi-Fi Direct® function is activated. If the Wi-Fi Direct® function is not activated, the reception device activates the Wi-Fi Direct® function in operation 74. The reception device with the activated Wi-Fi Direct function initiates a search operation for other activated devices in operation 75. Operation 75 may be repeatedly performed until the Wi-Fi Direct® connection is completed or a Wi-Fi Direct® group is formed. In operation 76, the reception device determines whether the transmission device is included in the devices (e.g., a search list) found in operation 75. In operation 76, the determination may be made by comparing the MAC address of the transmission device received in operation 72 with MAC addresses of the devices included in the search list. If the determination of operation 76 shows that the search list does not include the transmission device, operation 75 is repeated. Alternatively, if it is determined in operation 76 that the transmission device is included in the search list, the Wi-Fi Direct® connection with the transmission device is attempted and completed in operation 77. The connection may be completed when the transmission device verifies the connection with the reception device in response to the attempt of the Wi-Fi Direct® connection from the reception device.

According exemplary embodiments of the invention, in operation 35 of FIG. 6, a number of pieces of common data may be transmitted via NFC. The established NFC link may be maintained for a predetermined period of time, and regardless of the transmission of the common data, it may be determined whether the NFC link may be maintained according to the predetermined period of time. This may be distinguished from an existing content sharing method (e.g., Android Beam® of Android® OS) in which an established NFC link may be automatically cancelled once data has been transmitted via NFC. Further, one or more pieces of common data may not be transmitted continuously, and may be transmitted within a predetermined time period. In addition, if the predetermined time period has not elapsed, a UI using a pop-up message or a menu may be provided to ask the user whether to further transmit data.

For example, after operation 31 of FIG. 6, a period of time for maintaining the NFC link may be predefined or set arbitrarily by the user. Further, the state of the established NFC link (e.g., the remaining time period for maintaining the NFC link, a message or information to check whether additional content to be further transmitted is present, and the like) may be informed to the user through the UI. For example, the remaining time may appear on the touch screen via Always-on-Top (AOT) function, or be informed using a notification message (e.g., sound and/or display), such as a pop-up window, alarming sound or a widget. Further, the user may achieve information about the established NFC link through the UI. In addition, when the user seeks to further transmit other content via NFC, the user may provide an input (e.g., a predefined motion input or touch input) and inform the presence of the other content to be further transmitted, or the device may display a query on the display through the UI as described above.

Accordingly, the method of sharing one or more pieces of common data via NFC may apply to operation 37 of FIG. 6, in which one or more pieces of common data may be transmitted via non-NFC. For example, the transmission device may be enabled to transmit one or more pieces of common data to the reception device when the non-NFC link is set up and until the non-NFC link is cancelled. Further, while the non-NFC link is maintained, information about the set link (e.g., a link duration) and/or a query to ask whether other common data to be further transmitted is present may be provided to the user through the UI.

Referring back to FIG. 6, the reception device executes similar or the same component as the transmission device using the received common data in operation 38. According to aspects of the invention, the manager 112b of the reception device may determine a program to be executed with reference to type data contained in the received common data, and transfer the relevant information to the program executor 114b. The program executor 114b may execute a component of the program determined by the manager 112b using content data contained in the received common data. As a result, the reception device may be enabled to display the same screen that is currently being displayed (e.g., when sharing content associated with a component being currently executed in the foreground of the transmission device) or has been displayed (e.g., when sharing content associated with a component being currently executed in the background).

Further, if the reception device does not have a program to execute the received component, the manager 112b of the reception device may communicate with the wireless communication controller 116a, such as a Wi-Fi communication controller or a mobile communication controller, download the corresponding program from an application program provision server (e.g., Play Store® of Google® or App Store® of Apple®), and install the downloaded program. The manager 112b may obtain information about an application to execute the received content data by using type data (e.g., application mimeType in Android® OS) contained in the received information, and the reception device may be enabled to find a corresponding program from the program provision server using the obtained information. In another example, the transmission device may provide information used for installing the program to execute the received component to the reception device along with, or separately from, other data (e.g., type data and common data), and the reception device may download and install the corresponding program by utilizing the received information.

If one or more pieces of common data are transmitted from the transmission device to the reception device in operations 35, 36 and 37 using various methods, the reception device may determine which component of a program is to be executed in the foreground using the one or more pieces of common data. For example, the reception device may choose common data that may be first or last received from among the plurality of pieces of common data and execute a component of a program related to the chosen common data. Further, the reception device may display a list of components and/or programs related to the received multiple common data, and execute a component and/or a program selected from the list.

According aspects of the invention, based on the order in which the user of the transmission device selects content to be shared in operation 34 (e.g., a component associated with the first selected content or the last selected content may be executed), the component of the relevant program may be executed in the foreground. Further, information indicating the priority of execution may be included in the common data (e.g., type data), and the reception device may execute a component of a program in the foreground based on the priority of execution. The priority of execution may be predetermined according to the type of content, or may be determined arbitrarily by the user of the transmission device. According to aspects of the invention, type data of content with the highest priority may be transmitted from the transmission device to the reception device, whereas type data of the remaining content may not be transmitted.

The exemplary embodiment illustrated in FIG. 6 may also be applicable when the transmission device may be configured to share the same content with a plurality of reception devices. Some operations of FIG. 6 may be performed individually for each of the reception devices, and the other operations may be performed simultaneously for the plurality of reception devices. Further, the transmission device may transmit common data (e.g., second common data) simultaneously to the plurality of reception devices, and perform the other operations individually with respect to one or more reception devices. For example, the transmission device equipped with an NFC tag may be in contact with or within a reference proximity of one or more reception devices equipped with NFC tags, and exchange information (e.g., MAC address) that may be used for setting up a Wi-Fi Direct® link to one or more reception devices, and create a group, such as a Wi-Fi Direct® group, for one-to-many communication and transmit the common data to the one or more reception devices.

By using an orientation of the mobile device or an orientation relationship between the mobile devices, the exemplary embodiment illustrated in FIG. 6 may be selectively implemented along with different content sharing methods (e.g., the Android Beam®) that are in accordance with other algorithms. For example, if the transmission device is in contact with the reception device, both of which may be equipped with NFC tags, while being in a vertical position (or in a horizontal position), the content sharing process may be performed using the Android Beam® function. If the transmission device is in contact with the reception device, both of which may be equipped with NFC tags, while being in a horizontal position (or in a vertical position), the content sharing process may be performed according to exemplary embodiments of the present invention. For another example, if the transmission device and the reception device have the same orientation (e.g., both are in a vertical position or in a horizontal position) when the devices contact each other, the content sharing operation may be performed using the existing Android Beam®. However, if the devices have differing orientations (e.g., one of the transmission device and the reception device is in a vertical position and the other is in a horizontal position (or vice-versa)), the content sharing operation may be performed according to exemplary embodiments of the present invention. Further, during setting up a NFC link or in the subsequent procedures, the transmission device and the reception device may set up a link (e.g., a Bluetooth® link, a Wi-Fi Direct® link, etc.), either of the transmission device or the reception device may transmit an orientation value or orientation state information (e.g., horizontal position or vertical position information) to the other device or both the transmission device or the reception device may transmit such value or information to each other.

As described above, a content sharing method according to exemplary embodiments of the present invention may be distinguished from an existing content sharing method at least in that components of programs being currently executed in a foreground and even in a background can be targets of a sharing operation. Additionally, it may be possible to share one or more pieces of contents and to share contents of varying sizes, such as ones of larger capacity, which may be above a reference threshold, as well as content of smaller capacity, which may be below a reference threshold. Hence, according to the exemplary embodiments of the present invention, the number and types of content may not limited, and it may be possible to share content associated with components being executed in the foreground and even in background. When a transmission device executes an Internet browser in a foreground while running a contact program and playing a music file in a background, according to the existing sharing method, only a webpage being executed in the foreground and currently showing on a display of the transmission device may be a target of sharing operation. However, according to exemplary embodiments of the present invention, content (e.g., webpage) associated with the browser that is currently executed in the foreground of the transmission device, and also content of a program being executed in the background (e.g., both the contact information and the music file) can be targets of sharing operation.

According to exemplary embodiments of the present invention, it may be possible to share content associated with a component of a program being executed in a foreground of a mobile device and content associated with a component of a program being executed even in a background. The component may not be limited to a top component of a corresponding program. In addition, it may be possible to share a plurality of pieces of content by activating the NFC tag once or by performing content sharing procedures by the NFC tags. Further, the type of content as a target of sharing is not limited, such that possible share files may include files with larger capacity or a size above a reference threshold (e.g., multimedia files or document files).

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method for sharing content, comprising:
establishing a short range communication link between a first device and a second device;
identifying one or more components of a program being executed in at least one of a foreground and a background of the first device; and
transmitting, to the second device, common data of at least one of the identified components.

2. The method of claim 1, wherein the short range communication link is established by contacting the first device with the second device.

3. The method of claim 1, wherein the short range communication link is established by disposing the first device within a reference proximity of the second device.

4. The method of claim 1, wherein the short range communication link is established by using Near Field Communication (NFC).

5. The method of claim 1, further comprising:
establishing a wireless communication link between the first device and the second device.

6. The method of claim 5, wherein the wireless communication link is established by using at least one of a mobile communication network, Bluetooth, Wi-Fi, and Wi-Fi Direct.

7. The method of claim 5, wherein the transmitting of the common data comprises transmitting a first portion of the common data using the short range communication link, and transmitting a second portion of the common data using the wireless communication link.

8. The method of claim 5, wherein the transmitting of the common data comprises transmitting the common data using the short range communication link when a size of the common data is below a reference threshold, and transmitting the common data using the wireless communication link when the common data is above the reference threshold.

9. The method of claim 5, wherein the transmitting of the common data comprises transmitting the common data using at least one of the short range communication link and the wireless communication link based on a storage location of the common data.

10. The method of claim 1, further comprising:
transmitting, to the second device, information of the first device; and
establishing a connection between the first device and the second device using the information of the first device.

11. The method of claim 1, further comprising:
determining a transmission method for transmitting the common data; and
transmitting the determined transmission method using the short range communication link.

12. The method of claim 1, further comprising:
displaying a component list of the program for selection,
wherein the common data is selected from the component list.

13. The method of claim 1, wherein common data comprises at least one of content data related to the at least one of the identified components, and type data including information about programs executing the content data.

14. The method of claim 1, further comprising:
establishing a wireless communication link between the first device and the second device;
determining a transmission method for transmitting common data of at least one of the identified components; and
transmitting, to the second device, the common data of the at least one of the identified components according to the determined transmission method.

15. A first device, comprising:
a control unit to identify one or more components of a program being executed in at least one of a foreground and a background; and
a wireless communication unit to establish a short range communication link with a second device, and to transmit, to the second device, common data of at least one of the identified components.

16. The first device of claim 15, wherein the short range communication link is established when the first device is disposed within a reference proximity of the second device.

17. The first device of claim 15, wherein the short range communication link is established by using Near Field Communication (NFC).

18. The first device of claim 15, wherein the wireless communication unit further establishes a wireless communication link with the second device.

19. The first device of claim 18, wherein the wireless communication link is established by using at least one of a mobile communication network, Bluetooth, Wi-Fi, and Wi-Fi Direct.

20. The first device of claim 18, wherein the wireless communication unit transmits a first portion of the common data using the short range communication link, and transmits a second portion of the common data using the wireless communication link.

21. The first device of claim 18, wherein the wireless communication unit transmits the common data using the short range communication link when a size of the common data is below a reference threshold, and transmits the common data using the wireless communication link when the common data is above the reference threshold.

22. The first device of claim 18, wherein the wireless communication unit transmits a first portion of the common data using at least one of the short range communication link and the wireless communication link based on a storage location of the common data.

23. The first device of claim 15, wherein the wireless communication unit further transmits, to the second device, information of the first device, and establish a connection to the second device using the information.

24. The first device of claim 15, wherein the control unit determines a transmission method to transmit the common data, and the wireless communication unit transmits, to the second device, the determined transmission method using the short range communication link.

25. The first device of claim 15, further comprising:
an input/output unit to display a component list of the program,
wherein the common data is selected from the component list.
